(19) United States
(12) Patent Application Publication
(10) Pub. No.: US 2010/0183212 A1
(43) Pub. Date: Jul. 22, 2010

(54) METHODS AND COMPOSITIONS FOR IMAGING CARTILAGE AND BONE

(75) Inventors: Anthony F. Purchio, Taylorsville, UT (US); Ali N. Bahadur, South Jordan, UT (US); Sergio X. Vasquez, South Jordan, UT (US); Matthew Thomas Masner, Bountiful, UT (US)

Correspondence Address: MORGAN, LEWIS & BOCKIUS LLP (SF), One Market, Spear Street Tower, Suite 2800, San Francisco, CA, 94105, US

(73) Assignee: Numira Biosciences, Inc., Irvine, CA (US)

(21) Appl. No.: 12/684,816

(22) Filed: Jan. 8, 2010

Related U.S. Application Data
(60) Provisional application No. 61/143,383, filed on Jan. 8, 2009.
(60) Provisional application No. 61/186,975, filed on Jun. 15, 2009.

(51) Int. Cl. G06K 9/00

(52) U.S. Cl. 382/131

(57) ABSTRACT

The present invention relates in general to compositions, processes and apparatus for imaging, and in particular for improved preparation, collection and processing of images of specimens that include cartilage, particularly specimens of intact or disarticulated joints. Images of specimens according to the present invention include images obtained from X-ray microscopic computed tomography.

### CROSS REFERENCE TO RELATED APPLICATIONS

This application claims the benefit of priority of U.S. Provisional Patent Application Nos. 61/143,383, filed Jan. 8, 2009, and 61/186,975, filed Jun. 15, 2009, each of which is hereby incorporated by reference in its entirety.

### FIELD OF THE INVENTION

The present invention relates in general to compositions, processes and apparatus for imaging, and in particular for preparation, collection and processing of specimens containing cartilage to produce high resolution images, including images obtained with X-ray microscopic computed tomography.

### BACKGROUND OF THE INVENTION

Obtaining high resolution images of joints, particularly the differentiation between bone and cartilage, can be of benefit for the diagnosis and treatment of disorders and diseases that affect joints and other regions of the body that are prone to inflammation of cartilage and other connective tissue. However, high resolution images of the boundary region between bone and cartilage can be difficult to obtain using standard microcomputed tomography (“microCT”) imaging techniques.

Conventional bone and tissues analyses are performed by ashing/caliper measures and tissue staining on slides respectively. While ashing and caliper bone quantitation have been replaced by microCT for humans and larger animals, progress on small animal cartilage imaging has been slower to develop, particularly since traditional histological chemical staining is readily available and relatively inexpensive. Imaging of smaller animals is of use in studies that require analysis of large numbers of animal models, such as drug development and environmental impact studies.

MicroCT-based virtual histology imaging provides a high resolution system that can be simple to implement, relatively inexpensive, and more rapid than comparable methods of phenotyping anatomy, particularly anatomy of tissue samples, whole organs and whole organisms. Methods for increasing resolution of images obtained from microCT-based methods would be of benefit to applications utilizing such imaging methods.

### SUMMARY OF THE INVENTION

Accordingly, the present invention provides methods and compositions for increasing the resolution of images obtained from specimens, particularly specimens comprising cartilage and bone. The resolution of images obtained through methods such as microCT is increased by using methods and compositions of the invention for obtaining, staining and further processing specimens for imaging modalities.

In one aspect, the invention provides methods for producing a microCT image of a specimen containing cartilage. In one embodiment, the specimen is an intact or a disarticulated joint. In a further embodiment, the joint is a knee joint. In a further aspect, the specimen is stained using one or more staining compositions.

The advantage of the staining compositions and methods of the present invention is that these methods allow measurement of cartilage and the boundary between cartilage and bone. In traditional methods, cartilage in preclinical specimens is essentially invisible to the microCT scanner (see for example, FIG. 6, which is a microCT image of a knee joint imaged in the absence of contrast agent). The present invention allows visualization of soft tissues in joints (particularly intact joints) at an index of refraction less than that of bone with a refraction signature unique to cartilage by using radio-opaque contrast agents that infuse and bind to the tissues themselves.

Traditional stains (such as haematoxylin and eosin, alcian blue, alizarin red, Gomori's trichrome, and the like) only apply to stained 2-D histological sections on glass slides and are not useful in CT because X-rays are “blind” to these stains—i.e., these stains are radiolucent. In addition, physical characteristics of the traditional stains make them incompatible with many of the imaging methods described herein, such as incomplete diffusion, toxicity to personnel in high volume, high osmolarity gradients, and other disadvantages that are known in the art.

The methods and compositions described herein make cartilage apparent to microCT, allowing resolution of the tissues in three dimensions without resorting to damaging the specimen by slicing it into thin pieces as is required in traditional methods. The present invention allows one to digitally observe the specimen in all three planes, whereas in traditional methods in which the cartilage cannot be resolved in the image, an anatomical plane of interest must be chosen before sectioning and the other two viewable planes are therefore lost thereafter for that particular specimen.

In one aspect, staining compositions of the invention include PTA. In an exemplary embodiment, staining compositions include a 1% PTA solution. In a further embodiment, staining compositions also include additives. In a still further embodiment, staining compositions include one or more buffers.

In one aspect, staining compositions of the invention include an iodinated contrast agent. In an exemplary embodiment, the iodinated contrast agent includes ioxaglate.

In further embodiments, the specimen is stained multiple times prior to imaging.

In some embodiments, subsequent to staining, the stained specimen is injected with one or more compositions to provide increased resolution between apposing cartilage plateaus. This further injection is conducted prior to imaging.

In specific aspects, the stained specimen is scanned in an X-ray tomography scanner to produce a microCT image.

Advantages of using microCT analysis of specimens containing cartilage, particularly specimens that are the intact joints of small animals (such as rodent models of disease) over traditional histology include: the availability of three-dimensional images, flexible sample orientation, rapid processing, high-resolution and the non-destruction of specimens during imaging. In addition, bone and cartilage data for an individual specimen can be analyzed using data and image processing techniques, such as those described in U.S. application Ser. Nos. 12/162,376, filed Oct. 15, 2008 and 11/839,414, filed Aug. 15, 2007, each of which is hereby incorporated by reference in its entirety for all purposes and in particular for all teachings (including written description, figures and examples) related to obtaining and analyzing images obtained using microCT virtual histology methods. A further advantage of methods of the present invention is that specimen integrity is preserved during imaging, allowing for additional processing if necessary.

### BRIEF DESCRIPTION OF THE FIGURES

FIG. 1 is a microCT image from a specimen stained in a 1% PTA solution containing calcium for four days.

FIG. 2 is a microCT image from a specimen stained in a 5% PTA solution for three days.

FIG. 3 shows a sagittal and coronal microCT image of an intact joint specimen stained with Hexabrix.

FIG. 4 is a sagittal microCT image of an intact rat knee in which the specimen was stained in Hexabrix and then injected with calcium carbonate.

FIG. 5 is a coronal microCT image of an intact rat knee in which the specimen was stained in Hexabrix and then injected with calcium carbonate.

FIG. 6 is a microCT image of an intact rat knee where no contrast agent was applied to the specimen.

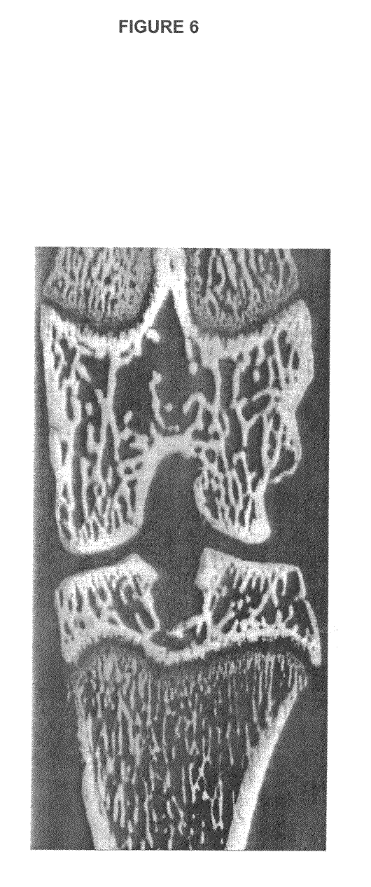

FIG. 7 is a photograph of an exemplary intact knee joint specimen.

### DETAILED DESCRIPTION OF THE PREFERRED EMBODIMENTS

Unless defined otherwise, all technical and scientific terms used herein have the same meaning as commonly understood by one of ordinary skill in the art to which this invention belongs. All publications mentioned herein are incorporated herein by reference for the purpose of describing and disclosing devices, formulations and methodologies which are described in the publication and which might be used in connection with the presently described invention.

Where a range of values is provided, it is understood that each intervening value, between the upper and lower limit of that range and any other stated or intervening value in that stated range is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either both of those included limits are also included in the invention.

In the following description, numerous specific details are set forth to provide a more thorough understanding of the present invention. However, it will be apparent to one of skill in the art that the present invention may be practiced without one or more of these specific details. In other instances, well-known features and procedures well known to those skilled in the art have not been described in order to avoid obscuring the invention. It will be apparent to one of skill in the art that these additional features are also encompassed by the present invention.

### DEFINITIONS

As used herein and in the appended claims, the singular forms “a,” “an,” and “the” include plural referents unless the context clearly dictates otherwise. Thus, for example, reference to “an agent” refers to one agent or mixtures of such agents, and reference to “the method” includes reference to equivalent steps and methods known to those skilled in the art, and so forth.

Unless defined otherwise, all technical and scientific terms used herein generally have the same meaning as commonly understood by one of ordinary skill in the art to which this invention belongs. Generally, the nomenclature used herein and the laboratory procedures in cell culture, molecular genetics, organic chemistry, and nucleic acid chemistry and hybridization described below are those well known and commonly employed in the art. Standard techniques are used for nucleic acid and peptide synthesis. The techniques and procedures are generally performed according to conventional methods in the art and various general references (see generally, Sambrook et al. MOLECULAR CLONING: A LABORATORY MANUAL, 2d ed. (1989) Cold Spring Harbor Laboratory Press, Cold Spring Harbor, N.Y., which is incorporated herein by reference), which are provided throughout this document. The nomenclature used herein and the laboratory procedures in analytical chemistry, and organic synthetic described below are those well known and commonly employed in the art. Standard techniques, or modifications thereof, are used for chemical syntheses and chemical analyses.

As used herein, a “specimen” is a biological specimen, which encompasses cells, tissues (including bone and joints), organs and whole organisms. The term “specimen” is used interchangeably with the term “sample” herein.

As used herein, the term “organism” refers to any living entity comprised of at least one cell. A living organism can be as simple as, for example, a single eukaryotic cell or as complex as a mammal. The term “organism” encompasses naturally occurring as well as synthetic entities produced through a bioengineering method such as genetic engineering.

As used herein, the term “tissue” includes cells, tissues, organs, blood and plasma.

The term “identifying” (as in “identifying an anatomical feature”) refers to methods of analyzing an object or property, and is meant to include detecting, measuring, analyzing and screening for that object or property.

A “property” is any biological feature that can be detected and measured.

The term “diagnosing disease” encompasses detecting the presence of disease, determining the risk of contracting the disease, monitoring the progress and determining the stage of the disease.

The “determining effectiveness of a treatment” includes both qualitative and quantitative analysis of effects of a treatment. Determining effectiveness of a treatment can be accomplished using in vitro and/or in vivo method. Determining effectiveness of a treatment can also be accomplished in a patient receiving the treatment or in a model system of the disease to which the treatment has been applied. In general, determining effectiveness of a treatment includes measuring a biological property at serial time points before, during and after treatment to evaluate the effects of the treatment.

“Treatment” generally refers to a therapeutic application intended to alleviate, mitigate or cure a disease or illness. Treatment may also be a therapeutic intervention meant to improve health or physiology, or to have some other effect on health, physiology and/or biological state. Treatment includes pharmacological intervention, radiation therapy, chemotherapy, transplantation of tissue (including cells, organs, and blood), and any other application intended to affect biological or pathological conditions.

The term “subject” refers to an organism that is the recipient of a biological and/or therapeutic intervention. A subject can be any organism, including cells, animals, and plants.

The term “patient” refers to a human subject that has a disease or has the potential of contracting a disease.

The term “microCT” refers to X-ray microscopic computed tomography.

The term “virtual histology” refers to methods by which specific tissues can be visualized using stains of the invention.

### Overview

The present invention provides compositions and methods for imaging specimens. In particular, the present invention provides compositions and methods for preparing specimens for imaging modalities (such as microCT virtual histology) to obtain images of cartilage, particularly cartilage in and around joints.

In one aspect, the present invention provides staining compositions for preparing specimens for imaging. Staining compositions of the invention are in specific embodiments tailored to improve the resolution of images obtained from specimens that include cartilage and bone, such as intact and disarticulated joints.

In further aspects, stains of the invention include electron dense staining agents such as phosphotungstic acid and ioxaglate.

In further aspects, specimens are processed to further improve the resolution provided by the stains. In some embodiments, incisions are made in certain regions of the specimens to improve penetration of the stains. In further embodiments, specimens are placed in fixatives prior to staining. In still further embodiments, specimens are injected with compositions to increase the contrast between apposing cartilage structures in stained specimens. In yet further embodiments, additives are included in the staining compositions that further improve the contrast between anatomical features.

In a further aspect, the present invention provides methods for obtaining images of specimens prepared according to the methods described herein. Any imaging modality known in the art can be used in methods of the present invention. In specific embodiments, imaging is accomplished using microCT virtual histology methods.

The methods and compositions of the present invention can be used in accordance with and/or in combination with the teachings of U.S. application Ser. Nos. 12/162,376, filed Oct. 15, 2008; 11/575,057, filed Jan. 29, 2008; 11/888,995, filed Aug. 3, 2007; 11/839,414, filed Aug. 15, 2007; 12/389,094, filed Feb. 19, 2009; 61/143,380, filed Jan. 8, 2009; and 61/230,574, filed Jul. 31, 2009, each of which is hereby incorporated by reference in its entirety, including all drawings, examples, and disclosure.

### Preparing Specimens for Imaging

In one aspect, the present invention provides methods and compositions for preparing specimens for acquisition of images. Preparing specimens for imaging includes dissection and further incisions upon the dissected specimen, fixing the specimens in one or more fixatives, staining the specimens in one or more staining agents that may include one or more additives, and further introducing additional compositions to improve the contrast between specific anatomical features.

In further embodiments, combinations of preparation methods are used to process specimens for imaging. As will be appreciated, any combination of such preparation methods described herein and known in the art can be used in accordance with the present invention. In some embodiments, staining agents are optionally combined with a buffer and/or a fixative and/or a cross-linking agent and/or a reporter substrate for a reporter gene product. As will be appreciated, any combination of such materials can be used to stain specimens in accordance with the present invention.

Staining Compositions

In one aspect, the invention provides staining compositions for preparing specimens for acquisition of images, such as microCT virtual histology images. Some components of such staining compositions are known in the art and described, for example, in International Publication No. WO/2007/089641, filed on Jan. 26, 2007 and U.S. application Ser. No. 11/575,057, filed Oct. 23, 2008, each of which is hereby incorporated by reference in its entirety for all purposes and in particular for all teachings related to preparing specimens for imaging, particularly microCT virtual histology imaging. In general, staining compositions of the present invention include staining agents (also referred to herein as “stains”) and may also include additional components such as buffers, fixatives, additives, and combinations of any of these. Staining compositions of the present invention show an increased resolution over conventional stains, particularly with respect to boundary differentiation between bone and cartilage in visualization methods such as microCT.

In some embodiments, staining agents of use in the present invention include an electron dense staining agent which produces an electron dense staining of one or more components of the specimen. Electron dense staining agents often include a metal atom or ion. Exemplary staining agents of use in the present invention include metals such as osmium (e.g., osmium tetroxide), tungsten (e.g., phosphotungstic acid, sodium tungstate), molybdenum (e.g., ammonium molybdate, phosphomolybdic acid), the noble metals, e.g., (platinum (e.g., cisplatin), gold (e.g, sodium chloroaurate)), bismuth (e.g., bismuth subnitrate), cadmium (e.g., cadmium iodide), iron (e.g., ferric chloride, potassium ferricyanide, potassium ferrocyanide), indium (e.g., indium trichloride), lanthanum (e.g., lanthanum trichloride), lead (e.g., lead acetate, lead citrate, lead nitrate), ruthenium (e.g., ruthenium red), silver (silver nitrate, silver proteinate, silver tetraphenylporphyrhin), thalium (e.g., thallium nitrate), uranium (e.g., uranyl acetate, uranyl nitrate) and vanadium (vanadyl sulfate). Other appropriate metals of use in the methods of the invention will be apparent to those of skill in the art.

In some embodiments, staining agents of use in the invention are iodinated contrast agents, such as ioxaglate (i.e., Hexabrix).

In general, the staining agent is present in staining compositions of the invention in any concentration useful to provide a desired level of contrast in the image of the specimen. Appropriate concentrations of a selected staining agent are readily determinable by those of skill in the art without resort to undue experimentation. For example, arrays of staining compositions including a single staining agent are prepared. Each composition is used to stain a specimen. The level of staining of each specimen by each staining composition is determined by acquiring a microCT virtual histology image of each of the stained specimens.

In an exemplary embodiment, the staining agent is present in the staining composition in an amount from about 0.01 weight percent to about 10 weight percent, preferably from about 0.1 weight percent to about 5 weight percent, more preferably from about 1 weight percent to about 3 weight percent.

Optionally, staining compositions of the invention further include at least one buffer component. The buffer is present in any concentration that is useful to provide a desired level of staining of the specimen, as evidenced, in one embodiment, by obtaining a desired level of contrast in a microCT image of the stained tissue. A buffer that has a different osmotic concentration than the tissue is optionally used in the process of stain penetration so as to accelerate transfer of stain molecules into components of the tissue, e.g., tissue cells.

Exemplary buffer concentrations for staining compositions of the invention range from about 0.01 M to about 1.0 M. In further exemplary embodiments, the buffer concentrations are in the range of about 0.05 to about 0.90, about 0.10 to about 0.80, about 0.20 to about 0.70, about 0.30 to about 0.60 and about 0.40 to about 0.50 M. In some embodiments, the buffer is a cacodylate buffer, e.g., sodium cacodylate trihydrate. In some embodiments, the buffer is a phosphate buffer. Other buffers known in the art may also be used in accordance with the present invention.

In further embodiments, staining compositions include at least one fixative or cross-linking agent component such as glutaraldehyde, formaldehyde, alcohols, or a combination of these. In exemplary staining compositions, the fixative or cross-linking agent is present in a concentration range of from about 0.05% to about 5%, preferably from about 0.1% to about 3% and more preferably from about 1% to about 1.5%.

In still further embodiments, staining compositions of the invention may also include a tissue penetration enhancing agent component. A representative tissue penetration enhancing agent is DMSO.

In further embodiments, staining compositions of the invention include both the staining agent and a species that is indicative or confirmative of the presence of a reporter gene through direct interaction with that gene or with a product of the reporter gene. In one embodiment, the reporter gene product forms a complex with the species recited above and the staining agent. The resulting agent is detectable by an imaging modality, e.g., an X-ray imaging modality, such as microCT.

In yet further embodiments, staining compositions of the invention may include at least one additive component. Such additives can be useful for semi-automated computational analysis of the resultant images, because these additives can help preserve bone landmarks (for example, trabecular structures). Preservation of bone landmarks allows data sets to be iteratively overlaid with accuracy. In specific embodiments, these additives include aqueous calcium. In further embodiments, aqueous calcium in the concentration of about 0.1 to about 5 M is used. In still further embodiments, aqueous calcium in the concentration of about 0.2 to about 4, about 0.3 to about 3, about 0.4 to about 2, and about 0.5 to about 1 M is used in staining compositions of the invention. In further specific embodiments, additives used in staining compositions of the invention include without limitation: calcium, potassium, manganese, magnesium, silica, iron, zinc, selenium, boron, phosphorus, sulfur, chromium, hydroxyapatite. As will be appreciated, such additives can be used individually or in combination with other additives or any of the other components of staining compositions described herein.

In still further embodiments, any combination of the above components is included in staining compositions of the present invention.

PTA Solutions

In specific embodiments, the staining agent used in staining compositions of the invention is phosphotungstic acid (PTA). In further embodiments, the PTA is present in concentrations from about 3 to about 10 weight percent PTA. In still further embodiments, the PTA is present in concentrations in the range of about 4 to about 9, about 5 to about 8, and about 6 to about 7 weight percent PTA. In yet further embodiments, the PTA is present in a range from about 4.8 to about 5.2 weight percent PTA.

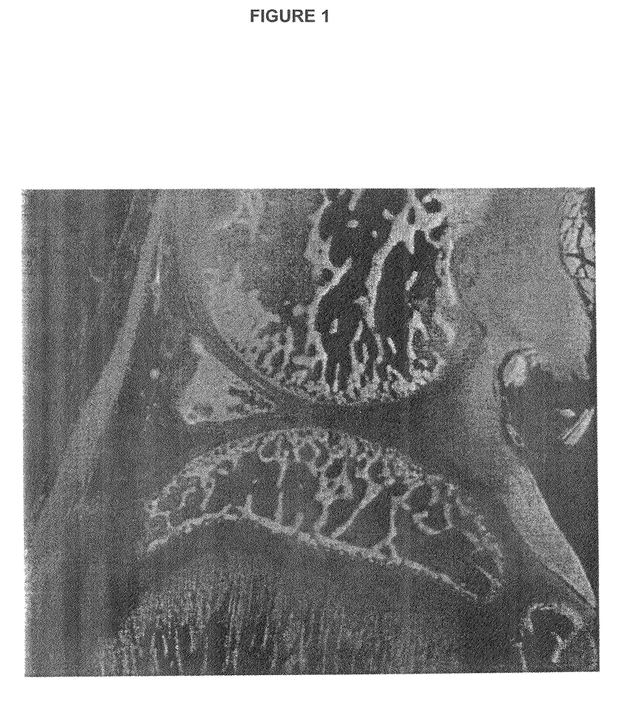

In further embodiments, staining compositions of the invention include PTA solutions in combination with calcium. In still further embodiments, the PTA solutions include phosphate. The addition of calcium and/or phosphate can include the resolution of images obtained using imaging applications such as microCT. For example, FIG. 1 shows a specimen stained for four days in a 1% PTA solution containing calcium.

In specific embodiments, a cartilage stain of the invention comprises a 1% PTA solution with 0.8 mM calcium chloride and a 10× phosphate buffer (10-fold dilution of a phosphate buffer comprising Na₂HPO₄/KH₂PO₄ at pH 7.4). It will be appreciated that the concentrations of the various components of the cartilage stain can be varied and that such variations also fall within the scope of the present invention. For example, the PTA solution may range from a 1% to a 20% solution. In yet further embodiments the PTA solution may range from 2%-18%, 3%-16%, 4%-14%, 5%-12%, 6%-10%, and 7%-8%. In a further example, the calcium chloride concentration may range from about 0.5 mM to about 10.0 mM. In still further embodiments, the calcium chloride concentration ranges from about 1.0 to about 9.0, about 1.5 to about 8.0, about 2.0 to about 7.0, about 3.5 to about 6.5, about 4.0 to about 6.0, and about 4.5 to about 5.0 mM. In a still further example, the phosphate buffer may be a 1×, 2×, 5×, or 10× solution.

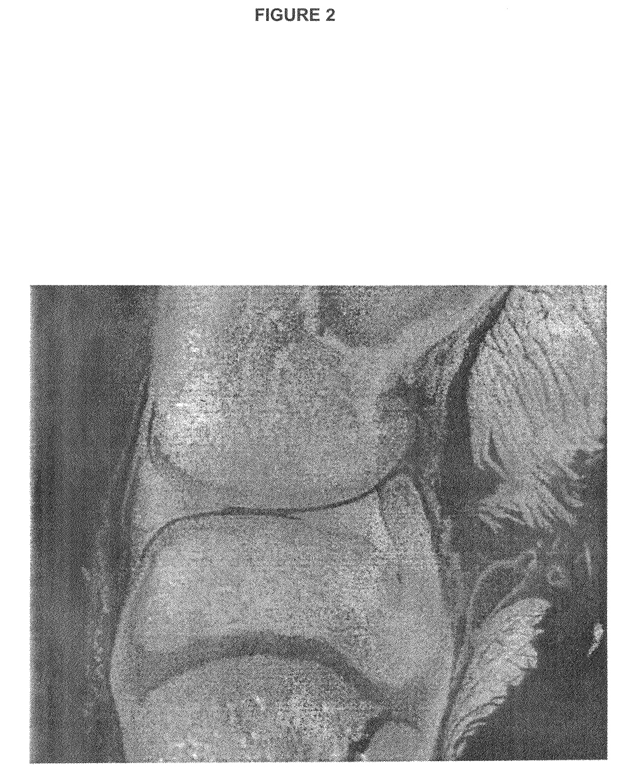

It will be appreciated that various combinations of the above described exemplary embodiments for staining compositions are encompassed by the present invention, and that the components of the staining agents described herein can be titrated to determine the combination that produces an optimal image of a particular specimen. For example, different PTA staining solutions will elucidate different anatomical features of a specimen, as is evident when comparing the images in FIG. 1 and FIG. 2. FIG. 1 is a microCT image of a specimen stained in a 1% PTA solution containing calcium for four days, and FIG. 2 is a microCT image of a specimen stained in a 5% PTA solution for three days.

It will be further appreciated that PTA solutions can be used with any of the other components of staining compositions described herein to stain specimens. In specific embodiments, 1% PTA solutions are used in combination with calcium and optionally other additives described herein in staining compositions of the invention.

Iodinated Contrast Agents

In one aspect, the present invention provides contrast agents for staining specimens that include cartilage, including specimens such as joints (intact and disarticulated). In specific embodiments, the present invention utilizes iodinated contrast agents such as ioxaglate i.e., Hexabrix (Mallinckrodt) to stain specimens for imaging.

In exemplary embodiments, staining compositions comprise full-strength (i.e., undiluted) Hexabrix. In other embodiments, staining compositions comprise a dilution of Hexabrix. In further embodiments, the dilution may range from a 1:2 to a 1:100 dilution. The dilution of Hexabrix may be in water, in a staining composition comprising any of the components described herein, saline, or any other medium known in the art.

It will be appreciated that iodinated contrast agents such as Hexabrix can be used with any of the other components of staining compositions described herein to stain specimens. In some embodiments, Hexabrix is used in combination with calcium and optionally other additives described herein in staining compositions of the invention.

Prior to incubation in a staining composition comprising Hexabrix, the specimen may first be fixed using any of the methods and compositions described herein and known in the art. In general, fixation prior to Hexabrix staining is conducted in a 10% buffered formalin solution for at least five days.

Subsequent to staining, the specimen may be injected with one or more of the injectable components described herein and known in the art to further delineate apposing cartilage layers.

Methods of Staining Specimens

Although staining agents are traditionally applied by oral administration, intravenous administration or direct injection into the area to be imaged, the present invention provides methods for staining intact tissue by incubation in the agent. The present inventors have found that although not traditionally thought to be able to penetrate intact tissue, certain staining agents are able to pass through tissue of an intact joint into the joint space to stain the specimen such that the boundary between bone and soft tissue can be differentiated using visualization methods such as microCT.

In an exemplary aspect, specimens are incubated for a selected period in a staining composition of the present invention. The period of time over which the specimen is incubated with the staining composition is readily determined by those of skill in the art and is informed by the level of contrast desired in the images acquired from the stained specimen. Incubation in staining compositions is generally conducted at ambient room temperature, but staining at higher and lower temperatures is also within the scope of the present invention.

In exemplary embodiments, the specimen is in contact with the staining compositions from about one hour to about one week. In still further exemplary embodiments, the specimen is in contact with the staining compositions for about nine hours to about five days, about twelve hours to about four days, about sixteen hours to about two days and about eighteen hours to about twenty-four hours. Periods of at least about three hours, at least about five hours, at least about ten hours and at least about fifteen hours are also of use in the methods of the invention

In some embodiments, the specimen is serially stained with two or more staining compositions. In further embodiments, such serial staining is conducted using the same kinds of staining compositions or using different kinds of staining compositions. For example, in some embodiments, the preparation of a specimen for imaging of cartilage comprises two separate PTA stains. In such embodiments, the specimen is stained for a period of time in a first staining composition comprising a PTA solution, and then re-stained in a second staining composition comprising a PTA solution. The first and second staining compositions may include identical PTA solutions or different PTA solutions. For example, the first staining compositions may include a 1% PTA solution whereas the second staining compositions may include a 1% PTA solution in combination with an additive such as calcium. As will be appreciated, serially staining as described herein can be conducted using staining compositions with any combinations of components described herein and known in the art.

In further embodiments, after incubation in a staining composition, specimens are transferred to one or a series of buffer solutions so as to remove extra staining agents and to create a density contrast between the specimens and the bordering environment to facilitate distinguishing of the tissue from its bordering environment. In some embodiments, the buffer has a different osmolality than that of the tissue to accelerate or otherwise enhance the transfer of stain molecules into components of the specimen, e.g., tissue cells. An exemplary buffer is a buffered saline solution, e.g., phosphate buffered saline (PBS). When this subsequent osmolality differential is applied, the staining composition can be of a greater or lesser osmolality than the buffer to which the stained specimen is subsequently submitted. Buffer solutions of use in the present invention can include without limitation sodium cacodylate buffer, phosphate-buffered saline, and ethanol solutions. In specific embodiments, transfers through buffers are conducted for the same or different periods of time. In further embodiments, these transfers (also referred to herein as “washes”) through buffers are conducted for about one to about five hours.

In yet further embodiments, the stained specimen may further be submitted to treatment with an organic solvent or a mixture of an organic solvent in water. Exemplary organic solvents are those that are at least partially soluble in water and include, e.g., alcohols, ethers, esters and the like. The medium in which the specimen is suspended can be altered from a first mixture (e.g., the staining composition) to a final mixture (e.g., 100% organic solvent) in a single step or, alternatively, the change in specimen environment can be accomplished by submitting the stained specimen to a gradient of medium compositions, moving step-wise or continuously from the first mixture to the final mixture.

In some embodiments, specimens are fixed prior to contact with staining compositions. In some embodiments, specimens are fixed through incubation in a formalin solution for a period of time. In some embodiments, the formalin is a 10% neutral buffered formalin solution. In further embodiments, the formalin can range from a 0.5 to a 15% neutral buffered solution. In some embodiments, the specimen is fixed for a period of about two to four days. In further embodiments, the specimen is fixed for a period of about one day to about two weeks. In still further embodiments, the specimen may be fixed for a month or longer.

In still further embodiments, after contact with one or more staining compositions, the stained specimen is further subjected to additional injection of “injectable” components. Such injectable components are of particular use in improving differentiation between apposing cartilage layers, for example in the region of the synovial space of a joint such as a knee joint. In exemplary embodiments, the injectable components are radio-opaque injectables suspended in a medium such as a lightweight oil or aqueous saline preparation. Other types of medium are known in the art and can be used in accordance with the present invention. Injectable components may also be suspended in a composition of the same or similar makeup as the staining composition used to stain the specimen. In specific embodiments, injectable components used in accordance with the present invention include 50% calcium carbonate suspended in a light oil medium. In further embodiments, these injectable components include without limitation: barium, barium sulfate, bismuth oxychloride, bismuth trioxide, bismuth potassium tartrate, bismuth subcarbonate, bismuth sodium iodide, bismuth sodium tartrate, bismuth sodium triglycollamate, bismuth subsalicylate, bromine, calcium carbonate, calcium sulfate, calcium chloride, ferrous carbonate, ferrous chloride, ferrous fumarate, ferrous gluconate, ferrous iodide, ferrous lactate, ferrous sulfate, ferrous succinate, gold, iodine, iron, magnesium oxide, magnesium sulfate, platinum, silver, sodium carbonate, tungsten, zinc, zinc acetate, zinc carbonate, zinc citrate, zinc iodate, zinc iodide, zinc lactate, zinc oxide, zinc phosphate, zinc salicylate, zinc stearate, zinc sulfate, and all combinations thereof. As will be appreciated, these injectable components can be introduced into the sample, particularly the synovial space of joints, using any method known in the art, including injection using a syringe.

In further embodiments, specimens are washed prior to, subsequent to, or both prior to and subsequent to incubation in a staining composition. In still further embodiments, specimens are washed prior to, subsequent to, or both prior to and subsequent to pre-stain fixation in solutions such as formalin and/or prior to, subsequent to, or both prior to and subsequent to exposure to injectables such as calcium carbonate in light oil medium. In specific embodiments, these washes are conducted in phosphate buffered saline (PBS) for about one to about five hours. In still further embodiments, multiple washes are conducted.

The methods of the invention preferably provide stained specimens in which the density of the staining is essentially invariant from one border of the specimen to an antipodal border of the specimen. As used herein, the term “essentially invariant” refers to the homogeneity of the staining of a specimen. In a preferred embodiment, a specimen exhibiting essentially invariant staining will have a density of stain that varies by no more than about 20%, more preferably by no more than about 10% and still more preferably by more than about 5% across a line through the specimen from a point on one border of the specimen to the antipodal point on the opposite border of the specimen.

As will be appreciated, any combination of methods and staining compositions described herein can be used to prepare specimens for imaging. Although specific embodiments of staining compositions and methods are described herein, it is within the skill of one in the art to alter components and procedures described herein and known in the art in to prepare specimens for imaging modalities such a microCT virtual histology.

In an exemplary embodiment, a specimen is prepared by first being fixed in 10% neutral buffered formalin for about 4 to about 5 days. The fixed specimen is then washed three times, one hour per wash, in PBS. The washed specimen is then stained for four days in a staining composition comprising a PTA solution. In further embodiments, the PTA solution is a 1% PTA solution. In still further embodiments, the 1% PTA solution will include calcium and phosphate. In some embodiments, this staining is conducted at room temperature. In further embodiments, the PTA solution is exchanged for fresh solution each day. The specimen is again washed three times, one hour per wash, in PBS and then subjected to a microCT scan to produce a first image. The specimen is then re-stained in a second PTA solution for three days. In some embodiments, the second PTA solution is a 5% PTA solution. In further embodiments, the 5% PTA solution will also include calcium and phosphate, as discussed above. In further embodiments, the PTA solution is exchanged for fresh solution each day. The re-stained specimen is then washed in PBS three times, one hour for each wash, and then subjected to a microCT scan to produce a second image. As will be appreciated, the types of PTA solutions, fixing solutions, and the amount of time spent in each solution can be varied to produce images of optimal resolution. In further exemplary embodiments, the second image and the first image are processed using methods known in the art to further elucidate anatomical features in the images. Such methods are described for example in U.S. patent application Ser. Nos. 12/162,376, filed Oct. 15, 2008 and 11/839,414, filed Aug. 15, 2007, each of which is hereby incorporated by reference in its entirety for all purposes and in particular for all teachings, description, figures and examples related to obtaining and processing images obtained using microCT virtual histology methods. In some embodiments, processing of multiple images obtained at various stages of staining involves a subtraction procedure, which provides data regarding anatomical features brought out by the re-staining process.

In a specific embodiment, an intact joint specimen is placed in an iodinated contrast agent. In one non-limiting example, the iodinated contrast agent is ioxaglate (Hexabrix). In a further embodiment, the specimen in Hexabrix is placed on a rocker to allow the stain to penetrate the specimen thoroughly. In some embodiments, the specimen is incubated in the Hexabrix at ambient room temperature. As discussed above, the specimen can be incubated in the Hexabrix for the amount of time needed to achieve the best resolution for the visualization method that is to be used. The staining may take place for about four hours to about one week. In some further embodiments, the specimen is incubated in the Hexabrix from about five to about forty-eight hours. In still further embodiments, the specimen is incubated in the Hexabrix from about ten to about thirty-six hours, from about twelve to about twenty-four hours, and from about sixteen to about twenty hours. In yet further embodiments, the specimen is incubated in the Hexabrix from about sixteen to about twenty-four hours.

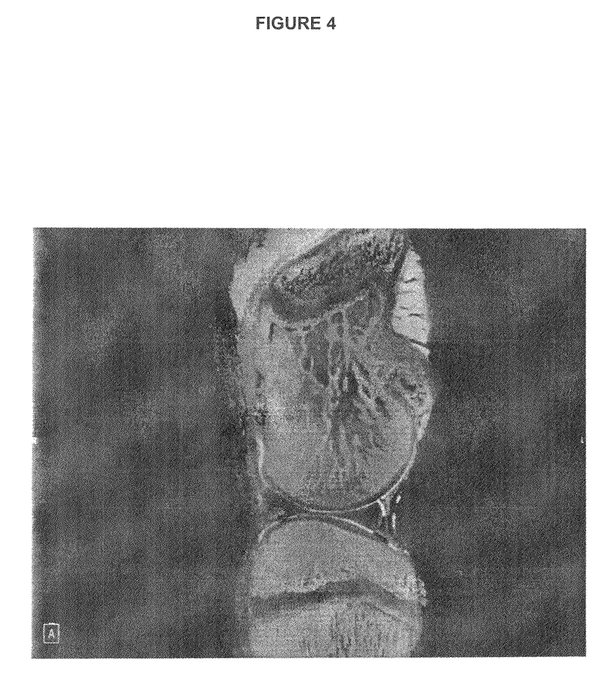

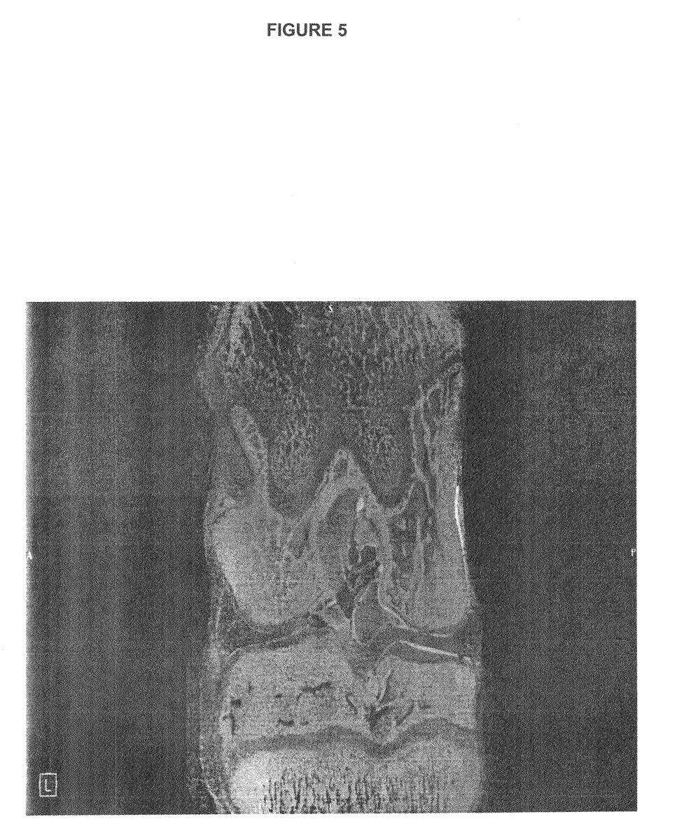

In further exemplary embodiments, after staining in Hexabrix, the specimen is injected with an injectable. In still further embodiments, the injectable is calcium carbonate. Injection of calcium carbonate improves the differentiation between apposing cartilage layers (see for example FIGS. 4 and 5, which show the saggital and coronal view of a rat knee stained with a solution containing Hexabrix and then injected with calcium carbonate suspended in Hexabrix).

The present inventors have found that although Hexabrix is of use in staining intact joints, not all contrast agents provide equivalently high quality images of intact (as opposed to disarticulated) joints. For example, osmium tetroxide and ethidium bromide are highly toxic in quantity, Ruthenium Red has low contrast, and Uranyl Acetate emits low level radioactivity when used in staining intact joints.

Methods of Dissection and Further Preparation of Specimens for Staining

In an exemplary aspect of the invention, the specimen stained is a “solid tissue”. As used herein, “solid tissue” refers to those tissues in which the parenchyma is present in an amount of at least about 50%. Solid tissue is distinct from tissue such as lung tissue.

In some embodiments, specimens stained according to the methods described herein comprise joints, including knee joints. In further embodiments, specimens such as knee joints are obtained from mammals such as rats and mice using dissection methods known in the art and described herein. In still further embodiments, specimens are prepared to enhance the penetration of the stains using blanching methods, incisions, and combinations of blanching and incisions.

Specimens of the invention can include joints, tissues, as well as whole organisms, e.g, an embryo or fetus.

In a further embodiment, penetration of staining compositions into a specimen is enhanced prior to or during treatment of the specimen with the stain. In an exemplary method, the porosity of the specimen is enhanced by chemical or physical methods. Exemplary chemical methods include osmotic disruption of the integrity of the specimen structure and treatment of the tissue with a penetration enhancing substance, e.g., DMSO. Physical means include, but are not limited to puncturing the specimen to form channels in the specimen through which the stain flows with greater facility than through corresponding undisrupted regions of the specimen. Channels can be formed in the specimen by puncturing it with an object or by subjecting it to focused energy, such as the light from a laser. in a general example of a staining process of the invention, a specimen, e.g., a cell, a tissue, an embryo, or a fetus, is stained to saturation for a selected period in a solution of 0.1 M buffer (pH 7.2), 1% fixative or cross-linking agent, and 1% staining agent, rocking at room temperature. The stained specimen is then washed and dehydrated. For example, specimens are washed for 30 minutes in 0.1M buffer, and twice more for 30 minutes in a second buffer providing an environment with an osmolality different from the staining solution and/or the washing buffer subsequent to the staining solution. Specimens are then incubated in a graded series of organic solvent concentrations to 100% organic solvent prior to imaging. An organic solvent is an example of a medium that increases the apparent density differences between the suspension medium and the stained tissue. In an exemplary staining process of the invention, a specimen, e.g., a cell, a tissue, an embryo, or a fetus, is stained to saturation overnight in a solution of 0.1 M sodium cacodylate (pH 7.2), 1% glutaraldehyde, and 1% osmium tetroxide, rocking at room temperature. The stained specimen is then washed and dehydrated. For example, specimens are washed for 30 minutes in 0.1 M sodium cacodylate buffer, and twice more for 30 minutes in phosphate-buffered saline. Specimens are then incubated in a graded series of ethanol concentrations to 100% ethanol prior to scanning. Ethanol is an example of a medium that increases the apparent density differences between the suspension medium and the stained tissue, thus further increasing the level of contrast in images obtained from specimens treated with such compositions.

### Imaging Methods

In one aspect of the invention, images of specimens prepared according to methods described herein are obtained using, for example, bioluminescence imaging, planar gamma camera imaging, SPECT imaging, light-based imaging, magnetic resonance imaging and spectroscopy, fluorescence imaging (especially in the near infrared), diffuse optical tomography, ultrasonography (including untargeted microbubble contrast, and targeted microbubble contrast), PET imaging, fluorescence correlation spectroscopy, in vivo two-photon microscopy, optical coherence tomography, speckle microscopy, and microCT imaging. Massoud et al. provide a detailed review of molecular imaging technologies (Genes and Development, 17:545-580, 2003), which is herein incorporated in its entirety for its teaching regarding molecular imaging.

In a further aspect, microCT methods of the present invention provide high resolution, non-destructive analysis of the status, integrity and development of biological tissues. In specific aspects, virtual histology methods are conducted according to methods and compositions described in U.S. application Ser. Nos. 12/162,376, filed Oct. 15, 2008; 11/575,057, filed Jan. 29, 2008; 11/888,995, filed Aug. 3, 2007; 11/839,414, filed Aug. 15, 2007; 12/389,094, filed Feb. 19, 2009; 61/143,380, filed Jan. 8, 2009; and 61/230,574, filed Jul. 31, 2009, each of which is hereby incorporated by reference in its entirety, including all drawings, examples, and disclosure related to microCT virtual histology imaging and processing of virtual histology images.

The sensitivity and specificity of microCT-based analyses provides a rapid and inexpensive method that enhances visualization and analysis of complex global 3-dimensional organization. Unlike traditional histology, which requires meticulous slicing and individual examination, the methods of the present invention includes staining specimens with specific dyes and scanning them with microscopic computed tomography (microCT), which provides a high resolution image of the whole specimen without the need for the slices required in other imaging modalities. The methods of the present invention provide a digital visualization with the capability of providing a number of measurements of various anatomical features of the specimen. Such measurements include without limitation distance, area and volume of such anatomical features.

Although the following section provides a description of embodiments in terms of microCT imaging, it will be appreciated that these methods can be adapted to other imaging technologies using methods known in the art.

In specific embodiments, specimens prepared according to methods known in the art and described herein are scanned in an X-ray computed tomography scanner to provide microCT images of the specimens. Virtual histology imaging methods are described in International Publication No. WO/2007/089641, filed on Jan. 26, 2007 and U.S. application Ser. No. 11/575,057, filed Oct. 23, 2008, each of which is hereby incorporated by reference in its entirety for all purposes and in particular for all teachings related to microCT virtual histology.

A microCT image is generated, for example, using a commercially available scanner, such as an eXplore Locus SP microCT specimen scanner (GE Healthcare, London, Ontario) or the eXplore Locus RS small animal microCT scanner (GE Healthcare, London, Ontario). More rapid volumetric CT scans of specimens may be performed at lower resolution, such as at 27 micron³ isometric voxel resolution, while longer higher resolution scans, such as 8 micron³ isometric voxel resolution, may also be performed, depending on the desired cost, time constraints and resolution required.

Parameters such as current, voltage, and exposure time are adjusted as appropriate and are kept constant for images to be compared. For each scan, a number of evenly spaced views may be averaged. The scans may be filtered, for instance to avoid saturation of the detector, using appropriate filters, such as 0.2 mm aluminum.

Images can be reconstructed using appropriate software, such as EVSBeam© software. Preliminary visualizations and virtual histology sections may be generated with the publicly available Micro View© program. Isosurfaces renderings and volume renderings of the CT datasets can also be generated as images.

In an exemplary embodiment, specimen scans with resolution of 3 microns or better are obtained in less than 12 hours. For example, isometric resolutions of 27 microns or 8 microns are achieved with scan times of 2 hours or 12 hours. MicroCT-based virtual histology matches or exceeds the tissue contrast achieved by more time- and cost intensive magnetic resonance microscopy, while delivering more than 2-fold higher resolution’ up to 8 microns for microCT, (Jacobs, R. E., et al., Comput Med Imaging Graph 23, 15-24 (1999), or in some cases up to 6 microns. For increased throughput of these types of studies, multiple specimens are optionally scanned simultaneously in the same field of view. For example, at lower microCT resolutions (27 microns), multiple specimens can be simultaneously scanned in approximately two hours with adequate quality for post-imaging segmentation analysis allowing the recognition of gross and subtle mutant phenotypes. For increased detail of abnormalities suspected on the low-cost 27 micron scans, the same stained specimens can later be scanned at 8 micron resolution for obtaining fine details such as organ sub-compartments and fine tissue structures.

The computed tomography image of a specimen, such as an organ or whole animal, may include an isosurface rendering so as to examine the exterior of the specimen for anatomical or molecular differences compared to other “control” specimens. In a further embodiment, the computed tomography image of the specimen may include a virtual section of the specimen.

Large numbers of images and associated data may be generated using micro computed tomography to image specimens. Such virtual histology datasets represent a valuable resource for investigating effects of certain experimental procedures, such as for example, genetic manipulation such as gene disruption or overexpression in vivo. However, generated datasets relating to one mutation or other variable at a particular stage of development or treatment may have further value when compared to a second mutation/variable or at a second stage. In order to facilitate access and aid in generation of such comparative data, a computer-based process for collecting, storing and retrieving micro computed tomography images and/or image data is provided according to the present invention. In one embodiment, such a process includes the steps of generating a digital computed tomography image, electronically transmitting the image and/or data to a centralized data storage location associated with a computer, retrieving the image and/or data from the storage location in response to a request and electronically displaying or transmitting the image and/or data and/or analysis of the image and/or data to a second location in response to the request.

A generated computed tomography image and/or data for generating such an image may be stored electronically, in memory circuitry such as a database, and/or on a computer readable storage medium. A generated computed tomography image is communicated to a repository for such images, a centralized image and/or image data storage location associated with a computer. Thus, for example, three-dimensional reconstructions of transgenic and wild-type mouse embryos are generated and images and/or data for image generation is sent to a centralized storage location associated with a computer. Such images and data for image generation may be generated and communicated from multiple locations for centralized storage.

Communication of generated images and/or image data is may be conducted over a wired or wireless connection to a device or system configured as a server or computer network accessible by multiple users from multiple locations. The server or computer network may include any type of computer device or devices such as a personal computer, workstation or mainframe computer.

Processing and memory circuitry is included in the server or computer network such that an image and/or image data may be communicated to memory circuitry and stored. Further, the stored information may be retrieved from the memory circuitry. Optionally included is a comparison program executable by the circuitry to carry out a comparison of one images or set of images with another set of images in order to characterize differences between the images relating to anatomical and/or molecular differences in specimens imaged. Such a comparison program may be stored and executed on a server or computer network which also includes the stored image and/or image data. A comparison program may also be stored and executed by a separate device to which images and/or image data retrieved from the memory circuitry of the server or computer network are downloaded.

An image and/or data for generating an image may be retrieved from the centralized storage location in response to a request. For example, a user inputs information to a device having data input and output capacity to communicate a request to retrieve an image and/or image data from the server or computer network storage location. The image and/or data may be displayed to the user and/or downloaded to the user's device. Further, the retrieved image and/or data may be retrieved for analysis and results of the analysis displayed or downloaded to the user.

In some embodiments, multiple images of different specimens or multiple images taken at different times of the same specimen will be compared to identify differences and similarities in anatomical features. In such embodiments, methods can be used to ensure that the images are co-registered to identify points in each image which correspond to points in the other images. Registration of images is a fundamental task in image processing used to match two or more pictures taken, for example, at different times, from different sensors, or from different viewpoints. Registration techniques are known in the art. (see, e.g., Brown., (1992), ACM Computing Surveys, 24(4): 325-76), and are also described in U.S. application Ser. No. 11/839,414, filed on Aug. 15, 2007, which is hereby incorporated by reference in its entirety for all purposes and in particular for all teachings related to image processing and comparing multiple images to each other and to reference images.

### EXAMPLES

### Example 1

### Staining for Cartilage Using Staining Compositions Comprising PTA Solutions

Knee joints were dissected from rat and washed in PBS.

The washed specimens were then fixed in 10% neutral buffered formalin for 4-5 days, followed by another series of washes in PBS. Three PBS washes were conducted—each for an hour with a solution change after each wash.

The specimens were then stained for four days in a PTA solution (1% in water) at room temperature. The PTA solution was exchanged for fresh solution each day. Some specimens were incubated in a staining composition containing a standard 1% PTA solution, while other specimens were stained in a stain that contained 1% PTA, 0.8 mM CaCl₂ and 1.25×PBS [PBS=NaCl 137 mM, KCl 2.7 mM, and phosphate buffer 10 mM (Na₂HPO₄/KH₂PO₄ pH 7.4) on 10× dilution.] The stained specimens were washed and subjected to a microCT scan.

The specimens were then stained in a 5% PTA solution for three days. Again, the PTA solution was exchanged for fresh solution each day. After staining, the specimens were washed in PBS three times for one hour for each wash. The washed specimens were then again subjected to a microCT scan.

### Example 2

### Preparing Specimens for Staining

In order to increase penetration of one or more stains in a specimen, the specimen may be blanched and/or incisions can be made in the specimens prior to staining.

When using whole animal specimens, for example E16 to P0 mice or rats, the specimen can be blanched and/or incisions may be made to open the thoracic pleura, abdominal peritoneum, and/or dura mater to further enhance stain penetration after skin removal.

The procedure for blanching the specimen can include making a small shallow “x” cut on the ventral and dorsal sides of the specimen. The specimen is placed in boiling water for approximately 10 to 12 seconds and then doused in ice water. A cotton tip swab or other implement can be used to gently rub the epidermis/dermis off of the specimen. Alternatively, the skin may be peeled from the specimen using fine forceps under a dissecting microscope. In order to remove extraneous membrane and tissue, the specimen may be further sealed in a container containing a solution such as PBS and placed on a rocking shaker for two to ten minutes. The treatment with PBS and the rocking shaker may be repeated multiple times as needed.

In addition to blanching, incisions may be made in the specimen to further enhance the penetration of the staining composition into tissues of interest.

To open the thoracic pleura, a short supracostal incision can be made with a scalpel above the 10th rib on the left lateral side of the body. Since nerves and vessels run below each rib, making the incision above the rib will less likely cause damage to a vessel and avoid unwanted hemorrhages. Additionally, since the 10th rib is located anterior-lateral to the gap between the lungs and the diaphragm, making the incision above the 10th rib will be less likely to cause damage to internal structures.

Using scissors with the tips up, the cut is extended along the top edge of the 10th rib to approximately 2-4 mm in length without damaging internal structures such as the lungs and heart.

The supracostal incision/cut is then repeated for the right lateral side of the body. The cut is generally no deeper than 1 mm from the surface in order to open only the thoracic pleura and not damage any internal organs.

To open the peritoneum, a small vertical incision can be made with a scalpel along the midline of the abdominal cavity approximately 1 mm above the umbilicus. Using micro-scissors with the tips up, the incision is extended to approximately 1.3 mm in length in the direction of the xiphoid process, cutting only the abdominal peritoneum without damaging any internal organs. The incision is generally less than 1.3 mm in length to ensure that the cut is inferior to the liver, thereby making it less likely that the liver is damaged. The cut is also generally no deeper than 0.3 mm from the surface to prevent damage to the intestines.

To open the dura mater, a 2-3 mm long incision with a scalpel can be made along the suture of the skull. The cut is generally no deeper than 0.5 mm from the surface in order to open the dura mater without damaging other structures in the brain.

Once all incisions are completed, the specimen can be transferred to a staining or fixing solution for further processing.

### Example 3

### Preparation and Imaging of an Intact Knee Joint of a Rat

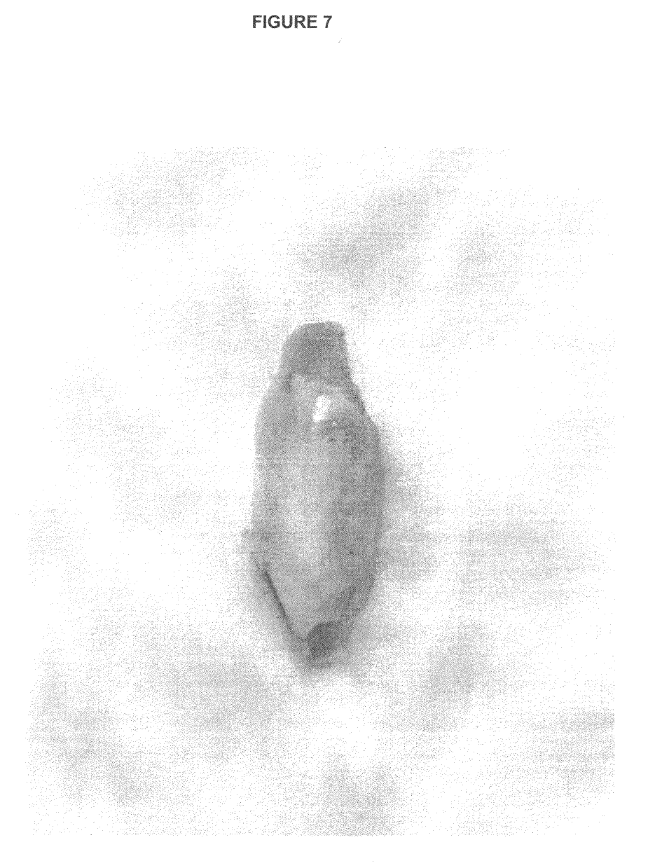

A rat was euthanized using institutionally approved protocols and an intact knee of a hindlimb was isolated by cutting through the midshaft of the femur and the midshaft of the tibia. The fascia surrounding the knee was trimmed without compromising the integrity of the intact joint (see FIG. 7).

The isolated knee sample was fixed in 10% Neutral Buffered Formalin for about seven days with agitation by gentle rocking.

The knee sample was then removed from the 10% Neutral Buffered Formalin and placed in 1×PBS to wash the excess fixation medium from specimen. The wash was repeated until all excess fixation medium was removed.

The knee sample was then placed in about twenty volumes of Hexabrix. The sample was placed on a rocker to allow the stain to penetrate the sample thoroughly for about twenty-four hours.

The sample was then removed from the Hexabrix and gently blotted dry using an absorbent material until all excess staining fluid was removed.

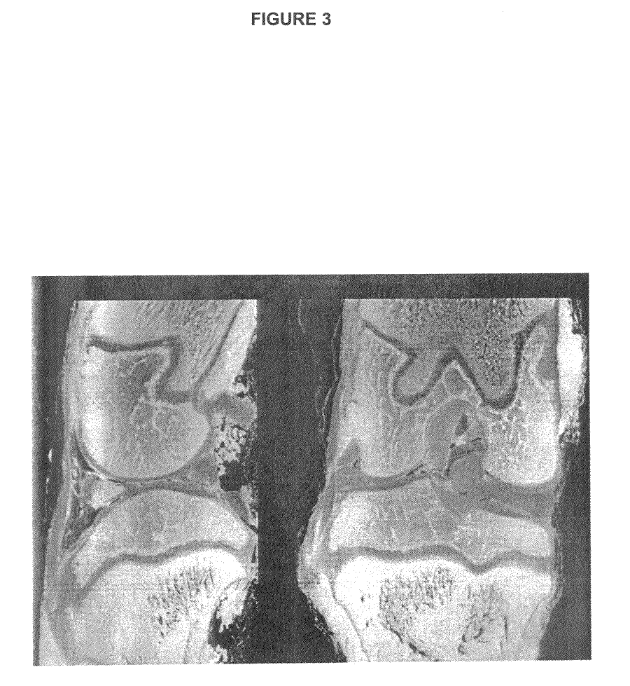

The sample was then placed in minimally attenuating material and secured for scanning. A small amount of aqueous solution was placed within the scanning stage to ensure that the specimen did not dehydrate, but the sample was not allowed to contact the aqueous solution. The platform scanning parameters were adjusted to effectively visualize cartilage as described in U.S. provisional application 61,143,383, filed Jan. 8, 2009, which is herein incorporated by reference in its entirety for all purposes and in particular for all disclosure (including written description, figures and examples) related to visualizing cartilage. Exemplary resultant images are shown in FIG. 3.

Seg3D was used to create a label map associated with the regions of interest (cartilage and bone) from the imaging data for each specimen. During this process, each voxel associated with a region of interest was assigned a specific value (e.g. 1 for cartilage, 2 for bone and 0 for background) which was then used for volume measurements. Teem (http://teem.sourceforge.net/) was then used to convert the label map and imaging data into frames for the planar movies and SCIRun (SCl Institute) was used to generate the frames for the rotating 3D movies.

The following calculations were performed to compute the volume measurements of the cartilage:
1. After the segmentation process, the voxel count associated with each region of interest was obtained (i.e. the number of voxels associated with the cartilage were counted using Seg3D).
2. The voxel count for each region of interest was then multiplied by the voxel resolution cubed to obtain volume measurements.
3. Based on the scanning parameters, the image data was collected at 10 μm isometric voxel resolution (10/1000 mm); the number of cubic millimeters in each voxel thereby translates into (10/1000)³. The voxel count was multiplied by (10/1000)³ to obtain the final measurement in millimeters cubed.

Surface Area Measurements: Based on the above obtained volume measurements, the number of voxels along the outside edge were counted to determine the surface area of the cartilage.

Thickness Map Generation: The distance from the bone to the edge of the cartilage was calculated by obtaining the total number of voxels in each distance then converting to millimeters. An image was generated which translate the distances into a color map to allow for viewing of the thickness along the length of the cartilage.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are herein incorporated by reference in their entirety for all purposes.

We claim:

1. A method of producing a microCT image of a first stained specimen, wherein said specimen comprises cartilage, said method comprising:
(a) incubating said specimen in a first staining composition wherein said first staining composition comprises a 1% PTA solution, to produce a first stained specimen; and
(b) scanning said first stained specimen in an X-ray tomography scanner,
thereby producing said microCT image of said first stained specimen.

2. The method of claim 1, wherein said specimen is a dissected knee joint.

3. The method of claim 1, wherein prior to said incubating step (a), said specimen is placed in a fixative comprising formalin.

4. The method of claim 1, wherein said first staining composition further comprises calcium, phosphate, or both calcium and phosphate,

5. The method of claim 1, said method further comprising:
(a) incubating said first stained specimen in a second staining composition, wherein said second staining composition comprises a 5% PTA solution, to produce a second stained specimen; and
(b) scanning said second stained specimen in an X-ray tomography scanner to produce a microCT image of said second stained specimen.

6. The method of claim 5, wherein said microCT image of said first stained specimen and said microCT image of said second stained specimen are processed to identify anatomical features present in said image of said second stained specimen that are not present in said image of said first stained specimen.

7. The method of claim 5, wherein said second staining composition further comprises calcium, phosphate, or both calcium and phosphate.

8. The method of claim 1, wherein prior to said scanning step (b), said first stained specimen is injected with an injectable component.

9. The method of claim 8, wherein said radio-opaque composition comprises calcium carbonate.

10. A method of producing a microCT image of an intact joint, said method comprising:
(a) incubating an intact joint in a contrast agent to produce a stained intact joint;
(b) scanning said stained intact joint in an X-ray tomography scanner,
thereby producing said microCT image of said stained intact joint.

11. The method of claim 10, wherein said intact joint comprises a knee joint.

12. The method of claim 10, wherein said contrast agent is an iodinated contrast agent.

13. The method of claim 12, wherein said iodinated contrast agent comprises ioxaglate.

14. The method of claim 10, wherein prior to said incubating step (a), said intact joint is placed in a fixative comprising formalin.

15. The method of claim 10, wherein prior to said scanning step (b), said stained intact joint is injected with an injectable component.

16. The method of claim 15, wherein said injectable component comprises calcium carbonate.
